(19) United States
(12) Patent Application Publication
(10) Pub. No.: US 2026/0253283 A1
(43) Pub. Date: Aug. 27, 2026

(54) SEQUENTIAL IMAGE GENERATION AND EDITING

(71) Applicant: Adobe Inc., San Jose, CA (US)

(72) Inventors: Xun Huang, Pittsburgh, PA (US); Tianwei Yin, Cambridge, MA (US); Richard Zhang, San Francisco, CA (US); Qiang Zhang, San Jose, CA (US); Elya Schechtman, Seattle, WA (US)

(73) Assignee: Adobe Inc., San Jose, CA (US)

(21) Appl. No.: 19/064,827

(22) Filed: Feb. 27, 2025

(51) Int. Cl. G06T 11/60; G06F 40/30; G06T 5/60; G06T 5/70

(52) U.S. Cl. CPC G06T 11/60; G06F 40/30; G06T 5/60; G06T 5/70; G06T 2207/20081

(57) ABSTRACT

Techniques for sequential image generation and editing are described. In an example, a query that specifies visual aspects to be included in a generated image is received for processing by a machine learning model. The machine learning model is configured to sequentially generate various image components that represent the visual aspects. Each image component, e.g., a layout representation, a background representation, and/or one or more object representations, is conditioned on previously generated image components. A digital image that includes the visual aspects is generated by integrating the various image components using the machine learning model.

### BACKGROUND

Text-to-image generation models have made significant advancements in recent years, enabling creation of high-quality images from textual descriptions. These models typically process a text query and globally generate a corresponding image in a single pass. However, conventional models struggle to generate images based on complex queries that specify multiple objects, define spatial relationships between objects, or include detailed scene compositions. Additionally, existing models lack fine-grained control over individual elements within the generated image, and thus exhibit an inability to edit or refine particular aspects of the image without causing unintended “off-target” changes. Accordingly, systems that implement conventional techniques experience limited controllability and editability which restricts practical applications of such systems. Further, these systems often require multiple calls to the model to attempt to obtain desired results which leads to inefficient use of computational resources and increased power consumption.

### SUMMARY

Techniques for controllable image generation and editing are described that support precise object-level control and identity preservation across edits. In an example, a processing device receives a query, e.g., a text-based input, that specifies visual aspects to be included in a generated image, such as one or more objects to be included in a scene. The processing device leverages a machine learning model, such as a multimodal large language model (MLLM) that includes an autoregressive diffusion transformer, to sequentially generate various image components that represent the visual aspects such that each image component is conditioned on previously generated image components. For instance, the processing device leverages the machine learning model to generate a layout representation that denotes a spatial arrangement of the objects within the scene based on semantic properties of the query. The processing device then generates a background representation that depicts the scene independent of the objects, followed by object representations for each of the objects specified in the query. The machine learning model then integrates the layout representation, background representation, and object representations to generate a digital image that depicts the objects within the scene in accordance with the spatial arrangement.

The techniques described herein further support fine-grained control over individual elements in generated images during editing operations. For instance, the processing device receives a request to apply an edit to a particular image component. The processing device then generates an edited digital image that depicts the particular image component with the edit applied while preserving the visual appearance of unedited image components. This approach overcomes limitations of conventional techniques that are unable to selectively modify portions of a generated image while maintaining consistency in unmodified portions. By representing images as sequences of editable components, the techniques described herein provide precise instance-level control and identity preservation across edits, which combines creative advantages of text-to-image models with precision of professional editing tools.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the sequential image generation and editing techniques described herein.

FIG. 2 depicts a system in an example implementation showing operation of a generation module of FIG. 1 in greater detail.

FIGS. 3a and 3b depicts an example to create a training dataset and using the training dataset to train the machine learning model in accordance with the techniques described herein.

FIG. 4 depicts an example of sequential image generation and editing in which a layout representation is generated based on an input query.

FIG. 5 depicts an example of sequential image generation and editing in which a digital image is generated.

FIG. 6 depicts an example of sequential image generation and editing in which an input is received to edit an image component of a digital image.

FIG. 7 depicts an example of sequential image generation and editing in which an input is received to edit an image component of a digital image.

FIG. 8 depicts an example of sequential image generation and editing in which an input is received to edit a layout of the digital image.

FIG. 9 depicts an example of sequential image generation and editing in which a digital image is generated based in part on a reference image.

FIG. 10 is a flow diagram depicting an algorithm as a step-by-step procedure in an example implementation that is performable by a processing device to sequentially generate and edit a digital image.

FIG. 11 is a flow diagram depicting an algorithm as a step-by-step procedure 1100 in an example implementation that is performable by a processing device to train a machine learning model to perform sequential image component generation.

FIG. 12 shows an example of a guided diffusion model according to aspects of the present disclosure.

FIG. 13 shows an example of a U-Net according to aspects of the present disclosure.

FIG. 14 shows an example of a method for conditional media generation according to aspects of the present disclosure.

FIG. 15 shows a diffusion process according to aspects of the present disclosure.

FIG. 16 shows a flow diagram depicting an algorithm as a step-by-step procedure for training a machine-learning model according to aspects of the present disclosure.

FIG. 17 shows an example of a method for training a diffusion model according to aspects of the present disclosure.

FIG. 18 shows an example of a computing device according to aspects of the present disclosure.

FIG. 19 shows an example of a generation apparatus according to aspects of the present disclosure.

FIG. 20 illustrates an example system including various components of an example device that can be implemented as any type of computing device as described and/or utilized with reference to FIGS. 1-19 to implement embodiments of the techniques described herein.

### DETAILED DESCRIPTION

### Overview

Artificial intelligence (“AI”) based image generation techniques often leverage machine learning models trained on vast datasets to produce high-quality and diverse images based on various inputs. Accordingly, such models are implementable in a variety of scenarios for a number of applications. However, conventional image generation techniques often face a limited ability to align outputs with specific user intents, such as generating scenes that include particular objects or attributes, particularly with complex input queries that specify multiple objects, define spatial relationships, include ambiguity, or describe detailed scene compositions.

For example, conventional models typically process a text query and generate image elements of an image “all at once.” This often causes the model to “miss” features included in the query and further limits fine-grained control over individual image elements within the generated image. Accordingly, such models are unable to selectively edit or refine discrete aspects of a generated image without causing unintended changes to other parts of the image.

Accordingly, techniques for sequential image generation and editing are described that overcome conventional limitations. The techniques described herein, for instance, support precise query adherence as well as object-level control and identity preservation across edits by representing images as sequences of editable components. Further, these techniques enable fine-grained adjustments to layout, shape, and identity of individual image elements while maintaining consistency in unmodified areas of the generated image.

Consider an example in which a user of a processing device wishes to generate an image of a specific scene, such as for a marketing campaign. The user, for instance, desires to generate an image that depicts a husband reading and a wife sunbathing on a tropical beach and further desires precise control over a position and appearance of each element within the image, such as to generate various options for the marketing campaign. However, conventional techniques that generate images “all at once” often fail to adhere to each of the conditions included in multi-condition input queries, e.g., complex or ambiguous queries.

Conventional approaches further exhibit limited control over individual elements of generated images. For instance, conventional models are unable to selectively edit or refine particular aspects of a generated image without causing unintended changes to other parts of the image. Accordingly, systems that implement conventional techniques often are reliant on multiple repeated attempts to regenerate images in accordance with user demands, which limits creative capability, offsets the advantages of generation models, and further causes inefficient use of computational resources and increased power consumption.

To overcome these limitations, a processing device receives a query for processing by a machine learning model that specifies visual aspects to be included in a generated image. The query, for instance, is a text-based input that includes one or more objects to be included in a scene, such as a string that includes the text “a husband reading and a wife sunbathing on a tropical beach.” The processing device leverages the machine learning model to sequentially generate various image components based on semantic properties of the query that represent the visual aspects. The image components, for instance, include one or more of a layout representation, a background representation, and object representations for each object included in the query. In various examples, the machine learning model is a multimodal large language model that is configured with that an autoregressive diffusion transformer architecture.

Each image component is generated individually and is conditioned on previously generated image components by the machine learning model such as to maintain consistency and coherence across the generated image components. In various examples, the processing device generates a processing plan, such as based on the semantic properties of the query, that specifies a sequence for the machine learning model to generate the various image components. For instance, the processing plan indicates to first generate the layout representation, followed by the background representation, and then generate object representations for each specified object in a particular order.

In this way, the techniques described herein support processing of complex queries in adherence with specified conditions by breaking down the image generation process into discrete steps. Further, the machine learning model is able to consider dependencies between components and ensure that each subsequent component remains consistent with previously generated components. Accordingly, the processing device maintains coherence and accuracy throughout the sequential generation process, which improves an overall quality and fidelity of the generated digital image.

Continuing with the above example, the machine learning model first generates a layout representation that includes bounding boxes to position the husband, the wife, and/or additional key elements of the tropical beach within the scene. The machine learning model next generates a background representation of the tropical beach without the husband and wife that is based on the layout representation. The machine learning model then generates one or more object representations, such as object representations for the husband and wife, each conditioned on the previously generated components such as the layout representation and the background representation. This sequential approach allows for precise control over each element's position, appearance, and relationship to other elements in the scene.

The processing device is operable to integrate the layout representation, background representation, and object representations using the machine learning model to generate a digital image that includes the visual aspects, e.g., depicts the objects within the scene in accordance with the spatial arrangement. For example, the digital image depicts the husband reading and a wife sunbathing on a tropical beach in accordance with the query. Because the image components are generated sequentially, the techniques described herein support identity preservation across edits.

For instance, the processing device receives a request to apply an edit to a particular image component. Continuing with the above example, the user wishes to change a position of the husband within the scene. Using conventional approaches, attempts to change a single element within the scene result in unintended changes to other parts of the image, such as to inadvertently replace the wife with a different individual, introduce visual artifacts, change the tropical beach scene, change facial representations of individuals within the scene, etc.

However, using the techniques described herein, the processing device leverages the sequential representation to apply the edit directly to the layout representation. Based on the edited layout representation, the machine learning model generates an edited digital image that depicts the particular image component with the edit applied while preserving the visual appearance of unedited image components. For instance, the edited digital image retains the same scene tropical beach scene and preserves the representation of the wife reading, however adjusts a position of the husband within the scene.

In this way, the techniques described herein overcome the limitations of conventional systems that lack fine-grained control over individual elements within generated images. Sequential generation of image components supports adherence to multi-condition prompts as well as precise adjustments to specific objects or scene elements without unintended modification. Thus, the techniques described herein enable efficient and controllable image generation and editing and further reduce a need for multiple regeneration attempts which conserves computational resources. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

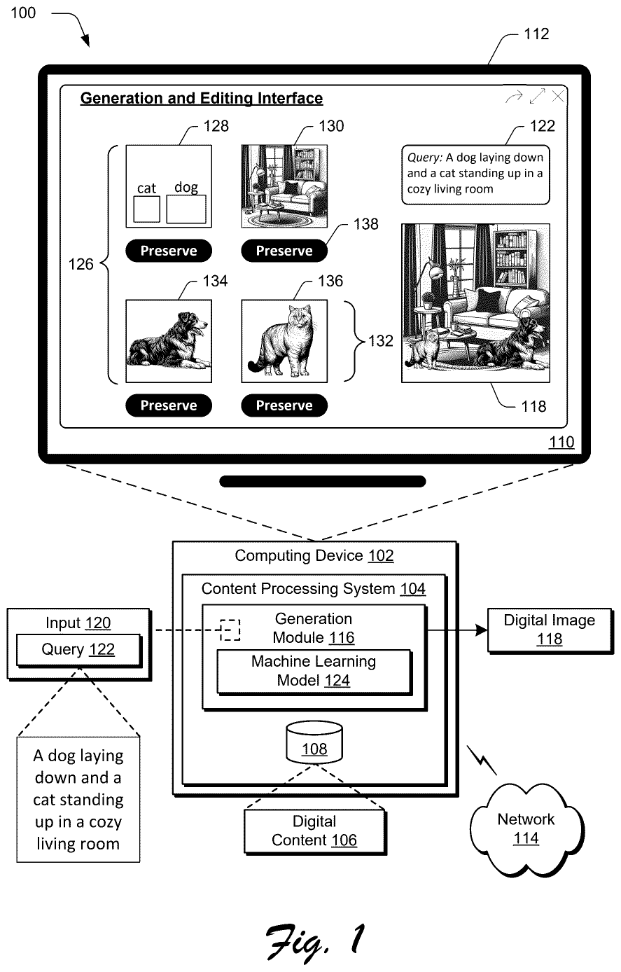

FIG. 1 is an illustration of a digital medium environment 100 in an example implementation that is operable to employ the sequential image generation and editing techniques described herein. The illustrated environment 100 includes a computing device 102, which is configurable in a variety of ways.

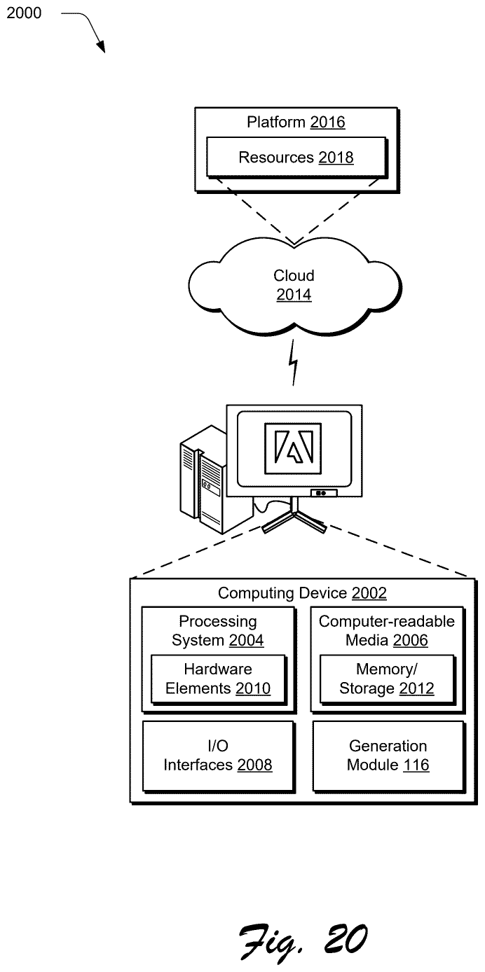

The computing device 102, for instance, is configurable as a processing device such as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 20.

The computing device 102 is illustrated to include a content processing system 104. The content processing system 104 is implemented at least partially in hardware of the computing device 102 to process and transform digital content 106, which is illustrated as maintained in storage 108 of the computing device 102. Such processing includes creation, modification, and/or rendering of the digital content 106 in a user interface 110 for output, e.g., by a display device 112. Although illustrated as implemented locally at the computing device 102, functionality of the content processing system 104 is also configurable in whole or in part via functionality available via the network 114, such as part of a web service or “in the cloud.

An example of functionality incorporated by the content processing system 104 to process the digital content 106 is illustrated as a generation module 116. This module is configured to generate and/or edit a digital image 118, such as based on an input 120 that includes a query 122, e.g., a text-based user query. The digital image 118, for instance, includes a variety of types of digital content 106 to visually represent aspects of the query 122, such as but not limited to still images, video frames, animated graphics, augmented reality (AR) content, virtual reality (VR) content, mixed reality (MR) content, 3D models, or combinations thereof.

The query 122, for instance, refers to a natural language question and/or command, such as to form a basis for an input to one or more machine learning models, e.g., a machine learning model 124. A variety of formats for the query 122 are considered, such as text-based queries, voice-based queries, visual queries, gestural queries, etc. In an example, the query 122 is provided in the user interface 110, such as to an AI-based image generation and editing application that implements the machine learning model 124.

In various examples, the query 122 includes a natural language request for information, task execution, search functionality, personalization, etc. to be performed by the machine learning model 124. For instance, the query 122 specifies visual aspects, objects, scene elements, individuals, properties, and/or features to be included in the digital image 118 generated by the machine learning model 124. The query 122 further includes one or more semantic properties. The semantic properties, for instance, are elements of the query 122 that define an intent, purpose, and/or requirements included in the query 122.

In various examples, the one or more semantic properties provide meaning to a query 122 beyond literal terms included in the query 122. Examples of semantic properties include but are not limited to an intent of the query 122, entities and/or keywords extracted from the query 122 (e.g., times, places, objects, locations, dates, etc.), actionable elements and/or terminology, relationships of tokens of the query 122 to one another, and/or contextual information. In some examples, the semantic properties further include properties of the query 122 such as a language style of the query 122, presence of keywords or text strings in the query, sentiment analysis information, task classification information, spelling, and/or grammar, etc.

In at least one example, the semantic properties define a context of a scene to be generated by the machine learning model 124 to include one or more objects. For instance, the semantic properties include one or more of an environmental setting (e.g., a time and place for the scene, weather, etc.), background information, individuals to be included in the scene (e.g., a number of individuals, visual properties of the individuals, demographic information about the individuals, etc.), actions and/or events to be depicted in the scene (e.g., dynamic elements and/or activities), spatial relationships (e.g., positional arrangements of objects in the scene), visual properties (e.g., style, perspective, tone, format, etc.) and so forth.

Based on the query 122, the generation module 116 leverages the machine learning model 124 to generate the digital image 118. As further described in more detail below, in various examples the machine learning model is configured as a multimodal large language model (“MLLM”) that integrates natural language processing and image generation capabilities into a singular architecture. In various implementations, the machine learning model 124 includes an autoregressive diffusion architecture that enables sequential processing of inputs, e.g., one or more queries 122, to generate outputs such as the digital image 118.

In an example to do so, the machine learning model 124 sequentially generates one or more image components 126 that are each conditioned on previously generated image components 126. For instance, the machine learning model 124 generates a processing plan based on the semantic properties of the query 122 that specifies a sequence for the machine learning model to generate the various image components 126. The image components 126, for instance, represent visual aspects of the digital image 118 and include a layout representation 128, a background representation 130, and/or one or more object representations 132. This sequential generation approach supports precise control over individual image components 126 and enables fine-grained adjustments and edits without inadvertently disrupting other aspects of the scene. Additionally, sequential generation of image components 126 based on semantic properties of the query 122 improves coherence and consistency in the digital image 118 and supports processing of complex queries.

In the illustrated example, for instance, the generation module 116 receives the query 122 that includes text “A dog laying down and a cat standing up in a cozy living room”. Based on semantic properties of the query 122, the generation module 116 leverages the machine learning model 124 to generate a processing plan, such as an order to generate the layout representation 128, the background representation 130, and the object representations 132. In various examples, the generation module 116 is operable to parse the query 122 into constituent components to differentiate between layout elements, object elements, and/or background elements included in the query 122 as part of generation of the processing plan.

In this example, the machine learning model 124 first constructs the layout representation 128 based on the semantic properties of the query 122. The layout representation 128, for instance, denotes a spatial arrangement of the one or more objects within the scene. As illustrated, the layout representation 128 includes bounding boxes that identify a size and position of different objects, e.g., a bounding box for the cat and a bounding box for a dog.

The machine learning model 124 next generates the background representation 130 that depicts the scene independent of the one or more objects. The machine learning model 124 is operable to condition generation of the background representation 130 on previously generated image components, such as the layout representation 128. In this example, the background representation 130 includes elements of the cozy living room environment described in the query 122, such as furniture, lighting, and decor, without the cat or dog depicted.

The machine learning model 124 then generates a first object representation 134 of the dog laying down. The first object representation 134 is generated based on previously generated image components, which in this example includes the layout representation 128 as well as the background representation 130. For example, the first object representation 134 is generated in accordance with spatial properties of the layout representation 128 and is configured to integrate seamlessly with the background representation 130. The first object representation 134 further includes discrete details such as a breed, pose, and texture of the dog.

The machine learning model 124 further generates a second object representation 136 that depicts a cat standing up. The second object representation 136 is generated based on the layout representation 128, the background representation 130, and the first object representation 134. In this way, the second object representation 136 is configured to integrate with both the background representation 130 and the first object representation 134 in accordance with the layout representation 128. The second object representation 136 further includes specific details about an appearance, posture, and position of the cat within the scene.

The generation module 116 leverages the machine learning model 124 to combine the sequentially generated image components 126, e.g., the layout representation 128, the background representation 130, the first object representation 134, and the second object representation 136 to create the digital image 118. This digital image 118 is then displayed in the user interface 110 on the display device 112 of the computing device 102. As illustrated, the digital image 118 depicts a scene of a cozy living room that includes a dog laying down and a cat standing up.

Whereas conventional techniques are limited to global edits and thus are unable to apply discrete generative edits to individual image elements, the techniques described herein leverage sequential generation to enable precise control over individual image components 126. For example, as depicted the user interface 110 includes selectable indicia, e.g., an icon 138, that are selectable to preserve one or more of the image components 126 during editing operations. Accordingly, the techniques described herein support modification of the layout representation 128, background representation 130, and/or individual object representations 132 while keeping other elements intact. This granular control allows for fine-tuned editing and refinement of the generated digital image 118 without affecting unintended parts of the scene, which is not possible using conventional image generation techniques. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Sequential Image Generation and Editing

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-11.

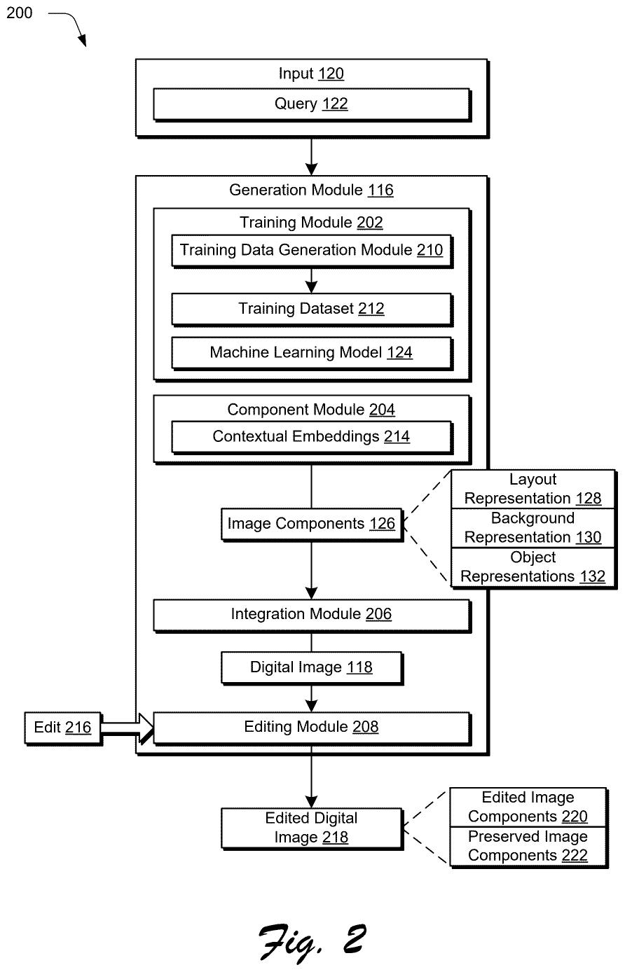

FIG. 2 depicts a system 200 in an example implementation showing operation of a generation module 116 of FIG. 1 in greater detail. Generally, the generation module 116 is configured to leverage a machine learning model 124 to generate a digital image 118 based on an input 120 that includes a query 122 via sequential generation of various image components 126. The generation module 116 is further operable to edit one or more of the image components 126 of the digital image 118 while preserving unedited components. The generation module 116 is depicted as including a training module 202, a component module 204, an integration module 206, and an editing module 208 that are operable to perform various aspects of sequential image generation and editing.

The training module 202, for instance, is configured to train the machine learning model 124 to sequentially generate the image components 126, such as based on various input queries. The training module 202 includes a training data generation module 210 that is configured to generate a training dataset 212. The training dataset 212, for instance, includes training samples that each include a training background image, at least one training object image, and annotations such as a training caption.

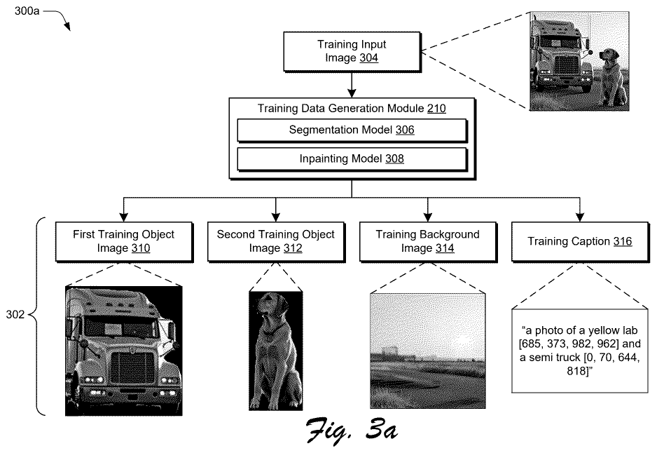

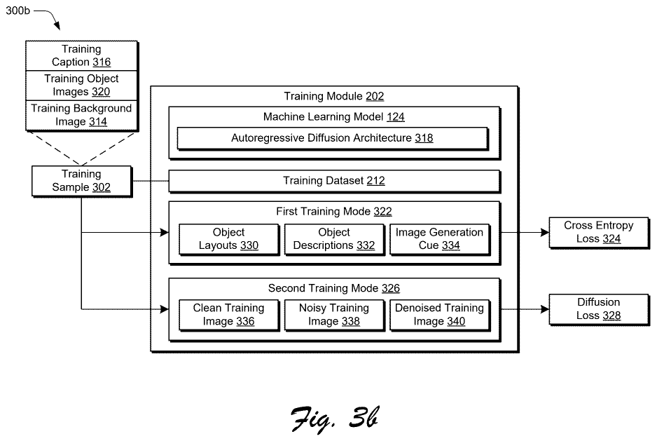

FIG. 3a depicts an example 300a of operations performed by the training data generation module 210 to create the training dataset 212 for the machine learning model 124. The example 300a, for instance, illustrates generation of a single training sample 302 for inclusion in the training dataset 212. In this example 300a, the training data generation module 210 implements a process of sequential object segmentation and inpainting to generate a comprehensive training sample 302.

To begin in this example, the training data generation module 210 receives a training input image 304. The training input image 304, for instance, depicts a complex scene that includes multiple objects, such as a semi-truck and a dog in an outdoor environment. To process the training input image 304, the training data generation module 210 leverages a segmentation model 306 as well as an inpainting model 308.

The segmentation model 306, for instance, is configurable to identify and extract individual objects from the training input image 304. In various examples, the segmentation model 306 utilizes one or more convolutional neural networks, mask R-CNN, or instance segmentation algorithms to accurately delineate object boundaries and separate distinct entities within the training input image 304. The training data generation module 210 is further configured to determine an order for generation of components of the training sample 302 based on various factors, such as complexity of the scene, a number and type of objects present, spatial relationships between objects, etc. In this example, the segmentation model 306 first extracts a visual representation of the semi-truck to generate the first training object image 310.

The training data generation module 210 further implements the inpainting model 308 to perform image reconstruction, such as to fill in regions of the training input image 304 that relate to the first training object image 310. In various examples, the inpainting model 308 includes one or more generative adversarial networks (GANs), partial convolutions, and/or contextual attention mechanisms to realistically reconstruct missing or removed portions of an image. In this example, the inpainting model 308 fills in regions of the training input image 304 that correspond to the extracted region that previously depicted the semi-truck.

The training data generation module 210 then repeats this process to generate the second training object image 312. For instance, the training data generation module 210 leverages the segmentation model 306 and the inpainting model 308 to segment the region of the training input image 304 that depicts the dog and fill in the corresponding region in the training input image 304. Accordingly, the second training object image 312 depicts a representation of the dog without the background.

The training data generation module 210 further generates a training background image 314 for inclusion in the training sample 302. The training background image 314, for instance, represents the scene with the previously identified objects removed and the resulting gaps filled in using the inpainting model 308 to create an object-free background. The training data generation module 210 leverages the inpainting model 308 to ensure that the background appears natural and consistent. In this example, the training background image 314 depicts the outdoor environment without the dog and semi-truck.

In addition to the first training object image 310, the second training object image 312, and the training background image 314, the training data generation module 210 also generates one or more training captions 316. The training caption 316, for instance, provides a textual description of the scene and includes details about the objects and spatial relationships of the objects within the scene. As illustrated, the training caption 316 includes specific coordinate information to precisely define locations of objects, e.g., the yellow lab and the semi-truck, within the scene.

In at least one example, the training data generation module 210 leverages an image captioner to generate the training caption 316. The image captioner, for instance, includes a machine learning model designed to generate textual descriptions of images. In various aspects, the image captioner combines computer vision techniques with natural language processing to analyze visual content and produce coherent captions. The image captioner model, for instance, includes convolutional neural networks for image feature extraction and recurrent neural networks or transformer architectures for text generation. This is by way of example and not limitation, and the training data generation module 210 is operable to generate the training caption 316 in various ways using various components.

Once generated, the training data generation module 210 includes the training sample 302 in this training dataset 212. The training data generation module 210 is further operable to repeat the above-described process for various training input images to expand the training dataset 212. While not depicted in the illustrated example, in examples in which the training input image 304 includes a facial representation, the training data generation module 210 is configured to extract a facial identity (such as within the training caption 316 and/or the training object images) for inclusion in the training sample 302. In this way, the machine learning model 124 is trainable to identify and/or preserve facial features throughout editing operations.

Further, in some examples the training sample 302 includes one or more additional signals. For example, the training sample 302 includes training metadata that describes additional aspects of the training input image 304. The training metadata, for instance, includes one or more of a depth map, object specific captions, scribble information, identity information, edge maps, pose information, etc. This is by way of example and not limitation and the training sample 302 is configurable to include a variety of additional information.

Using the above-described techniques, the training data generation module 210 is operable to create detailed and multi-faceted training samples 302. The training samples 302 support training the machine learning model 124 to understand scenes as compositions of distinct elements, facilitating precise control during image generation and editing. Further, the training dataset 212 enables the machine learning model 124 to learn multimodal relationships between textual descriptions, spatial layouts, and visual elements, and further supports an ability to generate and edit images in a sequential manner.

The training module 202 uses the training dataset 212 to train the machine learning model 124 in multiple stages. For instance, the training module 202 trains the machine learning model 124 to generate layout representations and image captions based on text-based queries in a first stage. In a second stage, the training module 202 trains the machine learning model 124 to generate digital images based on text-based queries using an iterative denoising process.

For instance, FIG. 3b depicts an example 300b of a training process to train the machine learning model 124 in accordance with the techniques described herein. In this example, the machine learning model 124 is configured to include an autoregressive diffusion transformer architecture 318 as further described below. The machine learning model 124 is trained using training samples 302 from the training dataset 212, which each include one or more training object images 320, a training background image 314, and/or a training caption 316. Generally, the training module 202 implements a two-fold training process that includes a first training mode 322 to generate a cross-entropy loss 324 and a second training mode 326 to generate a diffusion loss 328.

For instance, the training module 202 initiates the first training mode 322 to train the machine learning model 124 to generate object layouts 330 and object descriptions 332. In some examples, the object layouts 330 include one or more spatial arrangements, bounding boxes, and/or coordinate information that define positions and sizes of objects within a scene. Object descriptions 332, for instance, include textual information, attributes, and/or metadata that provide details about an appearance, characteristics, or relationships or objects within the scene.

In the first training mode 322, the training module 202 leverages aspects of the training sample 302, such as the training caption 316, as supervision for the training process. For instance, the machine learning model 124 generates prospective layouts and/or descriptions based on input text queries that correspond to training samples 302. The training module 202 compares generated outputs, e.g., the object layouts 330 and/or the object descriptions 332, to ground truth captions and layouts from the training samples 302, e.g., included in the training caption 316.

To evaluate performance in the first training mode 322, the training module 202 calculates a cross-entropy loss 324. The cross-entropy loss 324, for instance, includes a measure of a difference between two probability distributions, such as to quantify an error between predicted outputs and “actual” values. In various aspects, the cross-entropy loss 324 is calculated by comparing a predicted probability distribution generated by the machine learning model 124 with a “true” probability distribution of the target values. For example, the training module 202 generates the cross-entropy loss 324 based on a comparison between the object layouts 330 and/or the object descriptions 332, to ground truth captions and layouts from the training samples 302.

In at least one example, the cross-entropy loss 324 increases as the predicted distribution diverges from the true distribution, which provides a quantifiable indication of model performance that is usable to guide an optimization process during training. For instance, the training module 202 is operable to learn parameters and adjust weights of the machine learning model 124 to minimize the cross-entropy loss 324. In some examples, the loss is computed on a per-element basis for each training object image 320 and/or training background image 314 in a respective training sample 302.

In some implementations, the machine learning model 124 utilizes causal attention for processing text tokens during the first training mode 322. Causal attention, for instance, includes next-token prediction, where the machine learning model 124 predicts subsequent tokens based on the preceding ones in the sequence. Accordingly, the first training mode 322 teaches the machine learning model 124 to generate accurate object layouts 330 and object descriptions 332 based on textual inputs, using supervised learning techniques and cross-entropy loss 324 to refine the model's performance in understanding spatial relationships and object characteristics within scenes.

While in the first training mode 322, the training module 202 receives an image generation cue 334. The image generation cue 334, for instance, indicates to the training module 202 to switch training from the first training mode 322 to the second training mode 326. In at least one example, the image generation cue 334 is received once the machine learning model 124 has sufficiently optimized layout and description generation. For instance, the image generation cue 334 is received once the cross-entropy loss 324 has reached a threshold level.

In an alternative or additional example, the image generation cue 334 is received once the training module 202 has processed a particular training sample 302. For instance, the training module 202 implements a training schema to oscillate between the first training mode 322 and the second training mode 326 on a per training sample 302 basis. In some implementations, the image generation cue 334 is triggered based on properties of one or more training samples 302, such as a complexity of the scene or a number of objects present, which allows the content processing system 104 to adaptively allocate computational resources and/or transition between training modes efficiently.

Once the image generation cue 334 is received, the training module 202 transitions to a second training mode 326. In the second training mode 326, the training module 202 trains the machine learning model 124 to generate digital images using an iterative denoising process. The iterative denoising process, for instance, includes progressively removing noise and/or unwanted artifacts from data, such as an image, through repeated applications of a denoising algorithm. For instance, an initial noisy input is refined over multiple iterations by the machine learning model 124 to produce a clean output.

To train the machine learning model 124 to perform iterative denoising, the second training mode 326 involves adding Gaussian noise to clean training images 336 (such as the first training object image 310 and/or the second training object image 312) to create noisy training images 338. The machine learning model 124 then learns to generate denoised training images 340 through an iterative process, such as based on a text prompt associated with a particular training sample 302. To evaluate performance in the second training mode 326, the training module 202 calculates a diffusion loss 328.

The diffusion loss 328, for instance, measures of difference between a denoised training image 340 and a clean training image 336. In one example, the diffusion loss 328 includes a mean squared error (“MSE”) loss that computes a mean squared error between pixel values of the denoised training image 340 and the clean training image 336. In some examples, the diffusion loss 328 is updated on a per-element basis for each component of the training sample 302 to be processed.

The training module 202 continues to adjust parameters and learn weights of the machine learning model 124 to minimize the diffusion loss 328 throughout the second training mode 326, such as over the course of processing multiple training samples 302. Thus, the diffusion loss 328 is thus configured to guide the machine learning model 124 to learn to remove noise and reconstruct high-quality images during the denoising process. In some implementations, during the second training mode 326 the machine learning model 124 employs bidirectional attention for processing image patches to allow the machine learning model 124 to consider context from multiple directions when generating digital image content.

Once fully trained, the machine learning model 124 is configured as a multimodal large language model (MLLM) that integrates language modeling for sequence information with diffusion models for pixel rendering. The trained machine learning model 124, for instance, incorporates an autoregressive diffusion transformer architecture 318, which combines advantages of autoregressive models for sequential processing with capabilities of diffusion models for high-quality image generation. This architecture enables the machine learning model 124 to learn relationships between textual descriptions, spatial layouts, and visual elements. In this way, the machine learning model 124 is configured for sequential generation of image components 126, such as the layout representation 128, the background representation 130, and the object representations 132, which forms a basis for controllable image generation and editing capabilities of the system 200.

For example, once the machine learning model 124 is trained, the generation module 116 is operable to receive an input 120 that includes a query 122. The query 122, for instance, includes a text-based string that specifies visual aspects to be included in an image, such as one or more objects to be included in a scene. As described in more detail above, the query 122 includes semantic properties, such as elements, relationships, and/or contextual information extracted from the query 122 that provides meaning in addition to its literal interpretation, such as intent, entities, actions, sentiment, and/or conceptual relationships.

Based on the query 122, the component module 204 leverages the machine learning model 124 to generate one or more image components 126 to represent the visual aspects. The image components 126, for instance, include individual elements and/or aspects of a digital image that are sequentially generated and/or are individually editable. Image components 126 include, for example, one or more layout representations 128 that define spatial arrangements of objects, background representations 130 that depict scenes independent of objects, and/or object representations 132 that depict individual objects to be included in the image.

In some implementations, the component module 204 generates a processing plan based on the semantic properties of the query 122. The processing plan specifies a sequence for the machine learning model 124 to generate the various image components 126. For example, the processing plan indicates to first generate the layout representation 128, followed by the background representation 130, and then generate object representations 132 for each specified object in a particular order. This is by way of example and not limitation, and a variety of sequences for generation of the image components 126 are considered. This structured approach supports processing/parsing of complex queries 122 in adherence with specified conditions by breaking down image generation process into discrete steps.

In at least one example, the component module 204 generates a processing plan that prioritizes generation of particular objects based on semantic properties of the query 122. In an example, the semantic properties indicate that a particular object is highly relevant and accordingly the component module 204 generates the processing plan to generate the particular object last in the sequence. Thus, generation of an “important” object is conditioned on each of the other image components 126 to generate a contextually appropriate digital image 118.

As an example, the query 122 includes a text string “a majestic lion standing on a rocky outcrop overlooking a savanna at sunset,” the component module 204 generates a processing plan that indicates to first generate the layout representation 128 for the entire scene, followed by the background representation 130 of the savanna and sunset. The plan then specifies generation of object representations 132 for the rocky outcrop and any other environmental objects. The processing plan indicates to generate an object representation 132 for the lion last based on a determination that the lion is a central subject of the scene through semantic analysis of the query 122. Accordingly, generation of the lion object representation is conditioned on previously generated image components 126.

Additionally or alternatively, the component module 204 generates the processing plan based on optimization of computational resource utilization. For example, the component module 204 analyzes the semantic properties of the query 122 to determine an efficient order for generating image components 126 that minimizes redundant computations and maximizes reuse of intermediate results. For instance, the component module 204 generates a processing plan that prioritizes generation of relatively more complex image components 126 early in the sequence.

For instance, for a query 122 that specifies “a bustling city street with skyscrapers, cars, and pedestrians,” the processing plan indicates to generate the background representation 130 (to depict the city environment) before the object representations 132, (e.g., cars, pedestrians) to allow the machine learning model 124 to leverage information from earlier and relatively more complex generations to inform and simplify subsequent generations. For example, once the background representation 130 of the city is generated, the model is able to efficiently place and render cars and pedestrians within the established scene, which reduces a computational load to generate such elements. By generating the processing plan in this manner, the component module 204 is able to conserve computational resources and reduce overall processing time and energy consumption.

In accordance with the processing plan, the component module 204 generates the image components 126. Continuing with the above example in which the component module 204 first generates the layout representation 128, then the background representation 130, and ultimately the one or more object representations 132, the component module 204 constructs the layout representation 128 by processing the query 122 via the machine learning model 124. The machine learning model 124, for instance, leverages knowledge gained during training to analyze the semantic properties of the query 122 to determine spatial relationships and arrangements of objects within the scene.

For instance, the component module 204 leverages the learned understanding of the training machine learning model 124 to interpret and/or infer complex spatial descriptions and/or relationships between objects to create a coherent and structured layout representation 128 that aligns with an intent of the query 122. In one or more examples, the component module 204 generates the layout representation 128 based on factors such as object importance, relative positioning, and/or scene composition as implied by the query 122. In various embodiments, the layout representation 128 includes bounding boxes and/or coordinate information that define positions, sizes, and orientations of objects specified in the query 122.

In various examples, the component module 204 generates one or more contextual embeddings 214 as part of image component 126 generation. The contextual embeddings 214, for instance, represent previously generated image components 126, which the machine learning model 124 leverages as context to generate subsequent image components 126. Accordingly, the contextual embeddings 214 represent one or more of the layout representation 128, the background representation 130, and/or various object representations 132.

In some embodiments, the contextual embeddings 214 further represent properties of the query 122, e.g., the semantic properties. For instance, a contextual embedding 214 represents a detailed object description and/or caption generated by the trained machine learning model 124 based on the query 122. For instance, a particular contextual embedding 214 includes information about one or more objects beyond what is explicitly included in the query 122, such as information that is inferred by the machine learning model 124.

By way of example, a query 122 specifies a “dog” object however does not provide additional detail. The component module 204 leverages the machine learning model 124 to generate a contextual embedding 214 for the dog object that further includes details about a breed, pose, fur texture, etc. of the dog despite such specifics being absent from the query 122. The machine learning model 124 is operable to leverage this additional contextual information when generating the image components 126, such as to ensure consistency and promote fidelity in the generated digital image 118.

A variety of formats for the contextual embeddings 214 are considered. For instance, the contextual embeddings 214 include multi-dimensional vectors that capture semantic and spatial information about previously generated image components 126 and/or properties of the query 122. The vector representations encode complex relationships and attributes in a format that is processable by the machine learning model 124. In an alternative or additional examples, the contextual embeddings 214 include one or more tensors, multi-dimensional arrays, graph structures, hybrid formats that combines multiple representation types, etc.

Continuing in accordance with the above example processing plan, the component module 204 next generates the background representation 130. As described above, the background representation 130 depicts the scene specified in the query 122, independent of objects. In this example, the background representation 130 is based on the layout representation 128.

For instance, the component module 204 generates a contextual embedding 214 that represents the layout representation 128. Additionally or alternatively, the component module 204 generates a contextual embedding 214 that represents the query 122. The component module 204 then conditions the machine learning model 124 on one or more of the contextual embeddings 214 to generate the background representation 130.

In at least one example, the component module 204 generates the background representation 130 using an iterative denoising process by providing noise, e.g., Gaussian noise, to the machine learning model 124 as an input. Using the contextual embeddings 214 as context and leveraging the learned parameters and weightings, the machine learning model 124 generates the background representation 130 by denoising the initial noisy input over multiple iterations to produce a refined output. In this way, the background representation 130 is generated based on the layout representation 128 and the query 122 to ensure consistency between image components 126.

Following generation of the background representation 130, the component module 204 sequentially generates one or more object representations 132. In an example, a particular object representation 132 is generated based on the layout representation 128, the background representation 130, and/or the query 122. For instance, the component module 204 generates contextual embeddings 214 for the layout representation 128, the background representation 130, and/or the query 122.

The component module 204 then inputs a noisy image that includes Gaussian noise to the machine learning model 124. The machine learning model 124 further receives the contextual embeddings 214 which provide context for the machine learning model 124 during the denoising process. The machine learning model 124 iteratively denoises the noisy image to produce a clean object image that depicts an object. The component module 204 incorporates the clean object image into the particular object representation 132.

In an example in which the query 122 includes multiple objects, the component module 204 is operable to sequentially generate object repetitions 132 in an order prescribed by the processing plan. In some examples, each subsequently generated object representation 132 is further conditioned on previously generated object representations 132. For instance, the component module 204 generates a first object representation for a first object that is conditioned on the layout representation 128 and the background representation 130. The component module 204 then generates a second object representation for a second object that is conditioned on the layout representation 128, the background representation 130, and the first object representation.

This sequential generation approach supports processing of complex queries 122 in adherence with specified conditions by breaking down the image generation process into discrete steps. The techniques described herein further provide consideration for dependencies between components and ensure that each subsequent component generation step remains consistent with previously generated components. In this way, these techniques maintain coherence and accuracy throughout the sequential generation process, which improves an overall quality and fidelity of the generated digital image 118.

Once the image components 126 are generated, the integration module 206 is operable to combine the image components 126 to produce the digital image 118. For instance, the integration module 206 leverages the machine learning model 124 to integrate the separately generated image components 126. The digital image 118, for instance, depicts the one or more objects within the scene described by the query 122 in accordance with the spatial arrangement specified by the layout representation 128.

In some implementations, the integration module 206 applies a sequential compositing algorithm to merge these components. For instance, the integration module 206 first overlays the object representations 132 onto the background representation 130 in accordance with the spatial arrangement defined by the layout representation 128. The integration module 206 then performs color harmonization and blending operations to ensure seamless integration of the objects with the background.

The integration module 206 is further operable to apply additional image processing operations to ensure visual harmony between image components 126. For example, the integration module 206 adjusts lighting and shadows of the object representations 132 to match lighting conditions of the background representation 130. In some examples, the integration module 206 applies refinement techniques such as edge smoothing and/or texture matching to improve visual coherence between the merged components.

In various implementations, the integration module 206 leverages the machine learning model 124 to perform the integration process. For example, the integration module 206 inputs the image components 126 to the machine learning model 124 along with relevant contextual embeddings 214. The machine learning model 124 then generates the digital image 118 to combine the image components 126 while maintaining coherence and adhering to the specifications of the query 122. Thus, the digital image 118 incorporates the spatial relationships defined by the layout representation 128, an environmental context provided by the background representation 130, and detailed object depictions from the object representations 132 into a unified visual representation.

In various implementations, the editing module 208 receives a request to apply an edit 216 to a particular image component 126. The edit 216, for instance, includes an operation to apply a modification, alteration, adjustment, and/or change to one or more of the image components 126. In various examples, an edit 216 includes one or more of adding, removing, repositioning, transforming, and/or refining elements within the digital image 118. Due to the sequential generation approach described above, the techniques described herein support discrete generative edits to individual image components 126 without changing visual properties of other image components 126. This overcomes limitations of conventional techniques that generate an image “all at once” and thus are limited to global regeneration as a means of editing.

For instance, the editing module 208 maintains pixel embeddings for each image component 126, which permits direct manipulation with visual elements of the respective image component 126 without causing changes to other elements. The pixel embeddings further support affirmative preservation of particular image components 126. In this way, the editing module 208 is operable to generate an edited digital image 218 that includes edited image components 220 with the edit 216 applied while maintaining preserved image components 222.

In an example to generate the edited digital image 218, the editing module 208 initiates an additional pass of the machine learning model 124. For instance, the machine learning model 124 is operable to generate the edited digital image 218 based on one or more of the edit 216, the maintained pixel embeddings, the initial digital image 118, and/or the image components 126. The machine learning model 124, for instance, generates edited image components 220 that incorporate the requested changes and maintains preserved image components 222 that substantially maintain a respective visual appearance.

In at least one example, the machine learning model 124 identifies which of the image components 126 is to be edited and regenerates the edited image components 220 in accordance with the techniques described above (e.g., the iterative denoising process) and further incorporates the edit 216 as additional context during generation. The machine learning model 124 affirmatively maintains the preserved image components 222. The editing module 208 then leverages the machine learning model 124 to integrate the edited image components 220 and the preserved image components 222 to generate the edited digital image 218 in accordance with the techniques described above.

A variety of editing operations are considered. In one example, the edit 216 includes an action to move one or more objects within the digital image 118. For instance, the edit 216 modifies the layout representation 128 to reposition one or more bounding boxes. The editing module 208 generates the edited digital image 218 to depict the background representation 130 and the object representations 132 positioned in accordance with the modified layout representation 128.

In an alternative or additional example, the edit 216 includes an input to modify a visual attribute of a particular image component 126 while maintaining a spatial position of the particular image component within the scene. For instance, the generation module 116 receives an updated query to adjust a visual property, e.g., a color of an object. The editing module 208 analyzes the updated query to identify the edited image components 220 and the preserved image components 222 and applies the edit 216 to the edited image components 220. The editing module 208 then integrates the edited image components 220 and the preserved image components 222 to generate the edited digital image 218.

In an alternative or additional example, the edit 216 includes an input to replace a particular image component with a different object of a same category while preserving the layout representation. For instance, the editing module 208 receives an input to change a color, texture, or style of an object without altering its location. By way of example, the editing module 208 receives an input to replace a car object with a particular model of car, while maintaining a same position and size within the scene. The editing module 208 is operable to generate an updated object representation 132 for the particular car model based on the edit 216, while preserving other image components 126 such as the layout representation 128, the background representation 130, and unmodified object representations 132.

In additional or other implementations, the edit 216 includes adding an additional object to the scene. To do so, the editing module 208 is configured to generate an updated layout representation 128 that incorporates the additional object. The editing module 208 then generates an additional object representation 132 for the additional object. In some cases, the editing module 208 leverages the machine learning model 124 to generate the additional object representation 132 based on contextual embeddings 214 that represent previously generated image components 126. The editing module 208 is further operable to integrate the additional object representation 132 with the preserved image components 222 using the machine learning model 124 to generate the edited digital image 218. This approach allows for seamlessly adding new objects while maintaining consistency with existing scene elements.

In at least one example, the machine learning model 124 generates the digital image 118 and/or the edited digital image 218 based on one or more reference images. For instance, the generation module 116 receives a reference image that depicts a particular object, e.g., an image of a particular breed of dog. The machine learning model 124 is configured to analyze visual features of the reference image to identify the particular object and/or extract characteristics like color, texture, and/or shape. The machine learning model 124 generates an object representation 132 for the particular object and incorporates the extracted characteristics to produce an object that resembles the reference image while integrating coherently within the overall scene composition. Accordingly, the techniques described herein support precise control over targeted edits while preserving unmodified elements of the scene. This overcomes limitations of conventional techniques that generate an image “all at once” and thus are limited to global regeneration as a means of editing.

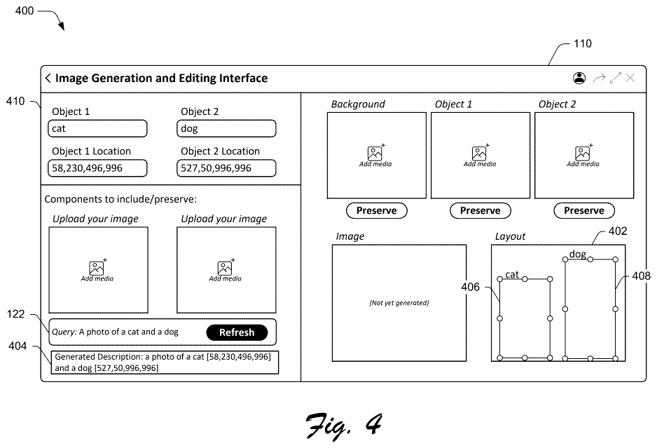

FIG. 4 depicts an example 400 of sequential image generation and editing in which a layout representation is generated based on an input query. As illustrated in the example 400, a user interface 110 displays various interactive elements that support the techniques described herein.

In this example, the generation module 116 receives a query 122 that includes a text string “A photo of a cat and a dog” for processing by the machine learning model 124. Based on semantic properties of the query 122, the generation module 116 generates a processing plan that indicates a prescribed order to sequentially generate various image components 126. In this example, the processing plan indicates to first generate a layout representation 128, then a background representation 130, and finally one or more object representations 132. Accordingly, the generation module 116 leverages the machine learning model 124 to sequentially generate the image components 126 in accordance with the processing plan. Thus, the generation module 116 first constructs the layout representation 402 based on the semantic properties.

The machine learning model 124 further generate an object description 404 based on the query 122 that includes coordinates for respective objects within the query 122. The object description 404 provides additional details about the objects specified in the query 122. In some implementations, the object description 404 includes information inferred by the machine learning model 124 beyond what is explicitly stated in the query 122. For instance, the object description 404 includes specific coordinate information for each object's position within the scene. In some examples, the layout representation 402 is generated based in part or in whole on the object description 404.

As illustrated, the layout representation 402 denotes a spatial arrangement of objects within the scene and includes a first bounding box 406 that represents the cat and a second bounding box 408 that represents the dog. The user interface 110 further includes a descriptive region 410 that populates information about the objects, including input fields for object names and locations, as well as areas for uploading reference images. In some aspects, the descriptive region 410 includes coordinate information for positions of each object within the scene.

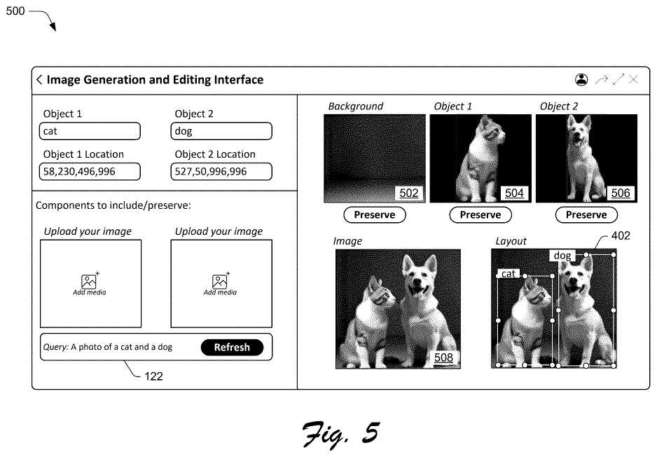

FIG. 5 depicts an example 500 of sequential image generation and editing in which a digital image is generated. The example 500, for instance, is a continuation of the example discussed above with respect to FIG. 4.

The generation module 116 utilizes the machine learning model 124 to sequentially generate the remaining image components 126, such as based on image components 126 that have already been generated. In various examples, this includes generation of a contextual embedding 214 that represents one or more of the image components 126 and inputting the contextual embedding 214 to the machine learning model 124 as context during inferencing. For instance, the machine learning model 124 generates a background representation 502 that depicts the scene independent of the objects specified in the query 122. Generation of the background representation 502 is conditioned on the layout representation 402 to ensure consistency with the overall scene composition.

The machine learning model 124 then generates a first object representation 504 for the cat. Generation of the first object representation 504 is conditioned on both the layout representation 402 and the background representation 502. This conditioning ensures that the cat is properly positioned and integrated within the scene and is visually consistent with the background.

The machine learning model 124 next generates a second object representation 506 to visually represent the dog. The second object representation 506 is conditioned on the layout representation 402, the background representation 502, and the first object representation 504. This sequential approach allows for coherent placement, interaction, and visual consistency between objects in the scene. In various examples, the machine learning model 124 implements an iterative denoising process to generate one or more of the image components 126 as described above.

The generation module 116 further leverages the machine learning model 124 to integrate the layout representation 402, the background representation 502, the first object representation 504, and the second object representation 506 to produce a composite image 508. The composite image 508 depicts the cat and dog within the scene in accordance with the spatial arrangement specified by the layout representation 402.

This sequential generation approach provides several advantages. For instance, the approach allows for precise control over individual components, enables processing of complex queries by breaking down the image generation process into discrete steps, and ensures consistency between objects and the background. Additionally, this approach supports subsequent editing operations by maintaining separate representations for each component.

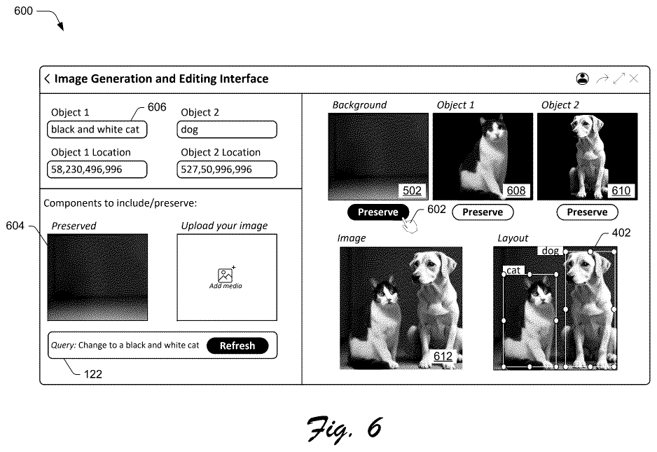

FIG. 6 depicts an example 600 of sequential image generation and editing in which an input is received to edit an image component of a digital image. The example 600, for instance, is a continuation of the examples described with respect to FIG. 4 and FIG. 5.

In this example, the generation module 116 receives an input 602 to preserve the background representation 502, such as via user selection of a “preserve” icon associated with the background representation 502. The generation module 116 further receives an updated query 122, which indicates to “change to a black and white cat.” The user interface 110 auto-populates relevant fields to display a preserved background representation 604, which indicates the background is preserved. The generation module 116 also changes a first object descriptor 606 from “cat” to “black and white cat”.

In accordance with the techniques described herein, the machine learning model 124 generates an updated first object representation 608 for the first object, such as a representation of a black and white cat. To do so, the generation module 116 generates contextual embeddings 214 that represent preserved image components 126, including the layout representation 402 and the preserved background representation 604. The machine learning model 124 is conditioned on this contextual embedding to generate the updated first object representation 608. The machine learning model 124 further generates an updated second object representation 610 for the second object, e.g., an updated representation of a dog, based on the layout representation 402, the preserved background representation 604, and the updated first object representation 608.

The generation module 116 then leverages the machine learning model 124 to generate a composite image 612. The composite image 612 includes the updated first object representation 608 and the updated second object representation 610, e.g., the black and white car and the updated dog. The composite image 612 further retains a same scene, e.g., as specified by the preserved background representation 604.

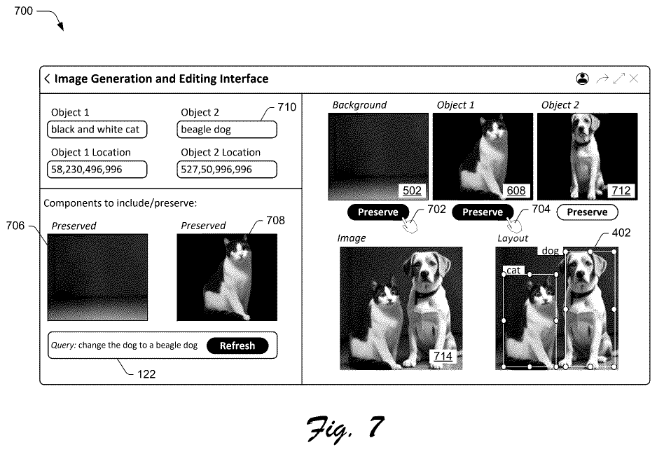

FIG. 7 depicts an example 700 of sequential image generation and editing in which an input is received to edit an image component of a digital image. The example 700, for instance, is a continuation of the examples discussed above with respect to FIGS. 4-6.

In this example, the generation module 116 receives an input 702 to preserve the background representation 502. The generation module 116 further receives an input 704 to preserve the first object representation 608 that depicts the black and white cat. The user interface 110 auto-populates relevant fields to display a preserved background representation 706, which indicates the background is preserved, and a preserved object representation 708, which indicates the black and white cat is preserved.

Additionally, the generation module 116 receives an updated query 122 that specifies a modification to the second object. In this case, the generation module 116 receives an updated query 122 that indicates to change the second object to a beagle dog. Based on this input, the generation module 116 updates the user interface 110 to display a second object descriptor 710 that reflects the requested change.

Responsive to the inputs, the machine learning model 124 generates a second object representation 712 that depicts the beagle dog. For instance, the machine learning model 124 leverages contextual embeddings 214 that represent the preserved background representation 706, the preserved object representation 708, and the layout representation 402. The machine learning model 124 is conditioned on these contextual embeddings 214 to generate the second object representation 712 that integrates seamlessly with the preserved components.

The generation module 116 then leverages the machine learning model 124 to generate a composite image 714. The composite image 714 incorporates the preserved background representation 706, the preserved object representation 708 of the cat, and the newly generated second object representation 712 of the beagle dog in accordance with the layout representation 402. In this way, the techniques described herein support selective edits and ensure that incorporated additions are contextualized within the existing composition.

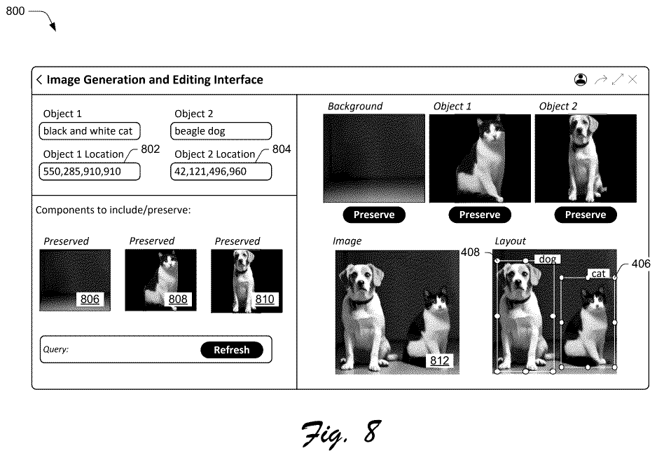

FIG. 8 depicts an example 800 of sequential image generation and editing in which an input is received to edit a layout of the digital image. The example 700, for instance, is a continuation of the examples discussed above with respect to FIGS. 4-7.

In this example, the generation module 116 receives an input to modify the layout representation 128, e.g., to adjust positions of objects within the scene. For instance, an input is received to reposition bounding boxes within the layout representation 128, e.g., to position the second bounding box 408 on the left and the first bounding box 406 on the right. Based on this input, the generation module 116 updates the user interface 110 to display an updated first object location descriptor 802 and an updated second object location descriptor 804. The first object location descriptor 802 and the second object location descriptor 804 indicate updated spatial positions for the respective objects within the scene.

The generation module 116 preserves all previously generated image representations during this layout update process. For instance, a preserved background representation 806, a preserved first object representation 808, and a preserved second object representation 810 are maintained. The generation module 116 then leverages the machine learning model 124 to generate a composite image 812 according to the techniques described herein. The composite image 812 incorporates the preserved background representation 806, the preserved first object representation 808, and the preserved second object representation 810, arranged according to the updated spatial positions specified by the updated layout representation 128.

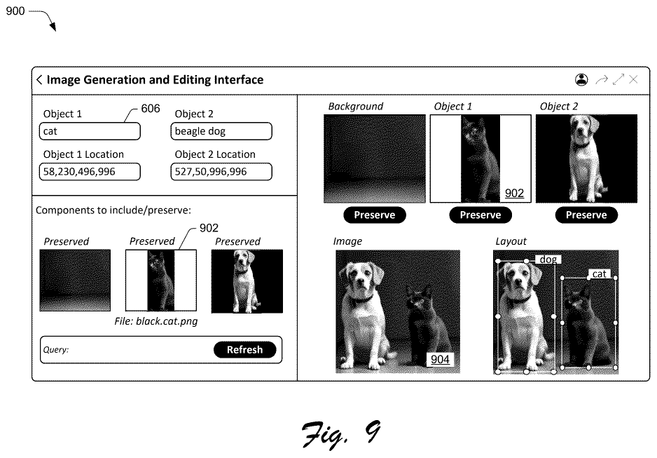

FIG. 9 depicts an example 900 of sequential image generation and editing in which a digital image is generated based in part on a reference image. The example 900, for instance, is a continuation of the examples discussed above with respect to FIGS. 4-8.

In the example 900, the generation module 116 receives an input to upload a reference image 902 that depicts a black cat. The generation module 116 processes the reference image 902 using the machine learning model 124 to extract visual features and characteristics of the black cat. For instance, the machine learning model 124 analyzes the reference image 902 to identify attributes of the black cat, such as color, texture, shape, etc. The machine learning model 124 further generates one or more contextual embeddings 214 that represent the layout representation 128, the background representation 130, and a preserved object representation for the dog.

The machine learning model 124 then generates an updated object representation 132 for the cat that incorporates the extracted features and is based on the contextual embeddings 214, such as to depict the cat included in the reference image 902 while maintaining consistency with the overall scene composition. The generation module 116 then leverages the machine learning model 124 to generate a composite image 904 based on the reference image 902 and the previously generated image components 126.

The composite image 904, for instance, incorporates the black cat from the reference image 902 while maintaining the spatial arrangement defined by the layout representation 128 and preserving the visual consistency of the background representation 130 and the object representation 132 associated with the dog. In this way, the techniques described herein support incorporation of external visual references into the image generation process. This approach enables users to customize generated images with specific visual elements while maintaining overall scene coherence and adhering to the spatial relationships defined in the layout representation 128.

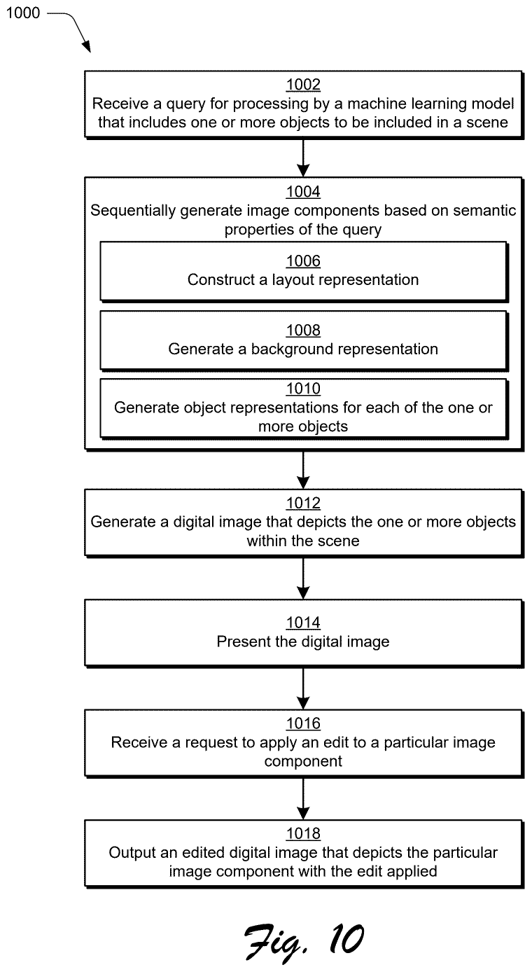

FIG. 10 is a flow diagram depicting an algorithm as a step-by-step procedure 1000 in an example implementation that is performable by a processing device to sequentially generate and edit a digital image.

To begin in this example, a query is received for processing by a machine learning model that includes one or more objects to be included in a scene (block 1002). The query 122, for instance, includes a text-based input that specifies visual aspects to be included in a generated image, such as objects, individuals, properties, and/or features to be included in a scene. In various implementations, the machine learning model 124 is configured as a multimodal large language model that includes an autoregressive diffusion transformer architecture.

One or more image components are then sequentially generated based on semantic properties of the query (block 1004). The image components, for instance, represent the visual aspects specified by the query 122. In some implementations, the generation module 116 generates a processing plan based on the semantic properties that specifies a sequence for the machine learning model 124 to generate the various image components 126. In various examples, the generation module 116 parses the query 122 into constituent components to differentiate between layout elements, object elements, and/or background elements included in the query 122 as part of generation of the image components 126.

In various examples, the sequential generation of image components 126 includes one or more substeps. For instance, a layout representation is constructed (block 1006). The layout representation 128, for instance, denotes a spatial arrangement of the one or more objects within the scene based on semantic properties of the query 122. In various examples, the layout representation 128 includes bounding boxes that identify a size and position of different objects within the scene.

A background representation is also generated (block 1008). The background representation 130 depicts the scene independent of the one or more objects. In at least one example, the machine learning model 124 generates the background representation 130 using an iterative denoising process. For instance, the machine learning model 124 inputs a noisy image that includes Gaussian noise and iteratively denoises the noisy image to produce a clean background image.

Object representations are then generated for each of the one or more objects (block 1010). In various implementations, generation of a particular object representation 132 includes generating a contextual embedding 214 that represents previously generated image components 126. The machine learning model 124 is conditioned on the contextual embedding 214 to generate the particular object representation 132.

A digital image is then generated that depicts the one or more objects within the scene (block 1012). The digital image 118, for instance, includes the visual aspects specified by the query and is generated via integration of the layout representation 128, the background representation 130, and the object representations 132 using the machine learning model 124. The machine learning model 124 is operable to harmonize visual properties of the respective image components 126 to ensure visual consistency.

The digital image is then presented (block 1014). For instance, the computing device 102 outputs the digital image 118 for display via a user interface 110. The digital image 118 depicts the one or more objects within the scene in accordance with the spatial arrangement specified by the layout representation 128.

A request is received to apply an edit to a particular image component (block 1016). The edit 216, for instance specifies modifications to attributes such as position, appearance, or other properties of the particular image component. A variety of edits 216 are considered, such as adjusting object positions or sizes, modifying visual attributes, replacing objects, and/or adding new elements to the scene. In an example, the edit 216 is processed by the machine learning model 124 to selectively modify the particular image component while preserving other elements of the scene.

An edited digital image is then output (block 1018). The edited digital image 218, for instance, depicts the particular image component with the edit applied and preserves a visual appearance (e.g., one or more visual attributes) of unedited image components. The machine learning model 124, for instance, integrates the edited image components 220 with the preserved image components 222 to generate the edited digital image 218. In some implementations, the machine learning model 124 applies additional refinements such as color harmonization or shadow adjustments to ensure seamless integration of the edited image components 220 with the preserved image components 222.

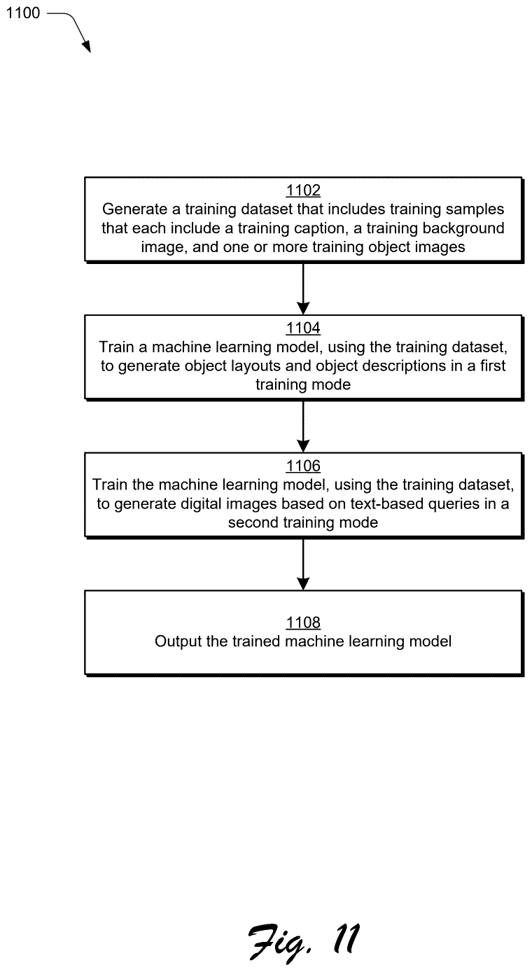

FIG. 11 is a flow diagram depicting an algorithm as a step-by-step procedure 1100 in an example implementation that is performable by a processing device to train a machine learning model to perform sequential image component generation.

To begin in this example, a training dataset is generated that includes training samples (block 1102). Each training sample 302, for instance, includes a training caption 316, a training background image 314, and/or one or more training object images 320. In various implementations, the generation module 116 processes training input images 304 using one or more of a segmentation model 306 and/or inpainting model 308 to extract individual objects and generate corresponding background images. In some examples, the training samples 302 further include additional control signals such as depth maps, scribble information, identity data, and/or pose information for objects.

The machine learning model is then trained using the training dataset to generate object layouts and object descriptions in a first training mode (block 1104). In the first training mode 322, for instance, the machine learning model 124 is configured to process text-based queries 122 and generate corresponding layout representations and/or image captions. The machine learning model 124 is evaluated in this mode by calculating a cross-entropy loss 324. In various implementations, the generation module 116 adjusts parameters and weights of the machine learning model 124 to minimize the cross-entropy loss 324 during the first training mode 322.

The machine learning model is further trained using the training dataset to generate digital images based on text-based queries in a second training mode (block 1106). In the second training mode 326, for instance, the machine learning model 124 is configured to implement an iterative denoising process for image generation. For instance, the generation module 116 adds noise to clean training images 336 to create noisy training images 338. The machine learning model 124 then learns to generate denoised training images 340 through one or more iterations. The generation module 116 evaluates the performance of the machine learning model 124 in the second training mode 326 using a diffusion loss 328. In various implementations, parameters, and weights of the machine learning model 124 are adjusted to minimize the diffusion loss 328 during the second training mode 326.

The trained machine learning model is then output (block 1108). The trained machine learning model 124, for instance, is configured as a multimodal large language model. In some implementations, the trained machine learning model 124 incorporates an autoregressive diffusion transformer architecture that enables sequential processing of inputs to generate image components. In this way, the machine learning model 124 is trained for efficient and flexible image generation and editing capabilities that are adaptable to diverse user inputs while maintaining visual coherence and fidelity across generated and edited components.

### Architecture: Pixel Diffusion

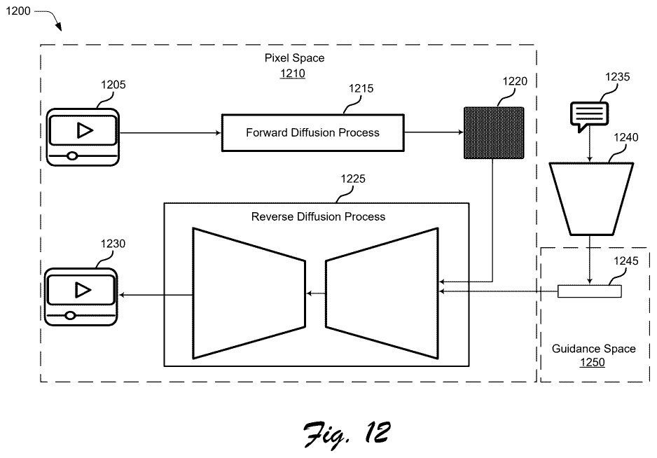

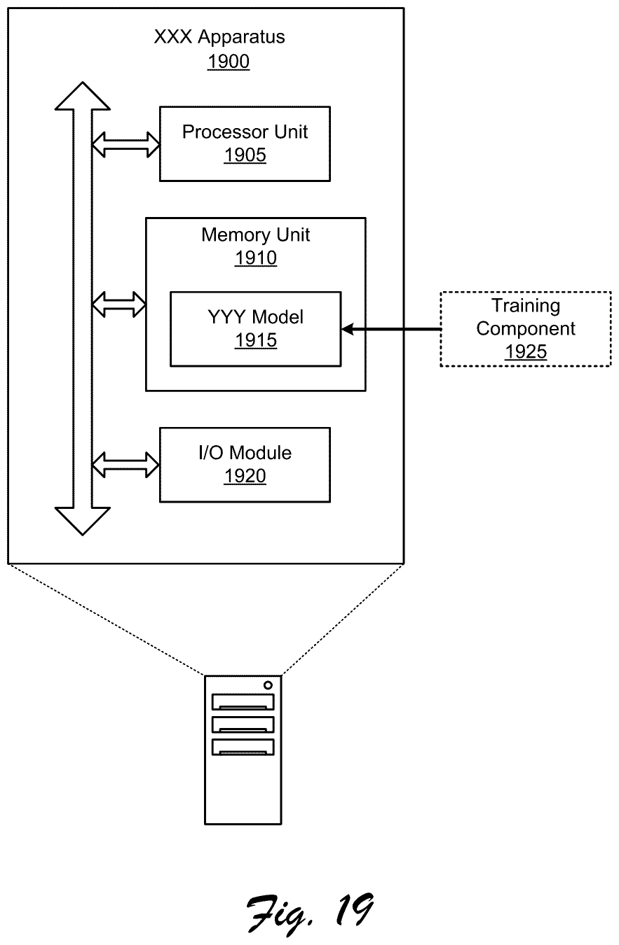

FIG. 12 shows an example of a guided diffusion model 1200 according to aspects of the present disclosure. In some examples, guided diffusion model 1200 describes the operation and architecture of the generation model 1915 described with reference to FIG. 19. The guided latent diffusion model 1200 depicted in FIG. 1 is an example of, or includes aspects of, a media generation model as described herein such as the machine learning model 124 described above in more detail.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 1200 may take an original media item 1205 in a pixel space 1210 as input and apply forward diffusion process 1215 to gradually add noise to the original media item 1205 to obtain noisy media item 1220 at various noise levels.

Next, a reverse diffusion process 1225 (e.g., a U-Net) gradually removes the noise from the noisy media item 1220 at the various noise levels to obtain an output media item 1230. In some cases, an output media item 1230 is created from each of the various noise levels. The output media item 1230 can be compared to the original media item 1205 to train the reverse diffusion process 1225.

The reverse diffusion process 1225 can also be guided based on a text prompt 1235, or another guidance prompt, such as an image, a layout, a segmentation map, etc. The text prompt 1235 can be encoded using a text encoder 1240 (e.g., a multimodal encoder) to obtain guidance features 1245 in guidance space 1250. The guidance features 1245 can be combined with the noisy media item 1220 at one or more layers of the reverse diffusion process 1225 to ensure that the output media item 1230 includes content described by the text prompt 1235. For example, guidance features 1245 can be combined with the noisy features using a cross-attention block within the reverse diffusion process 1225.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-NET

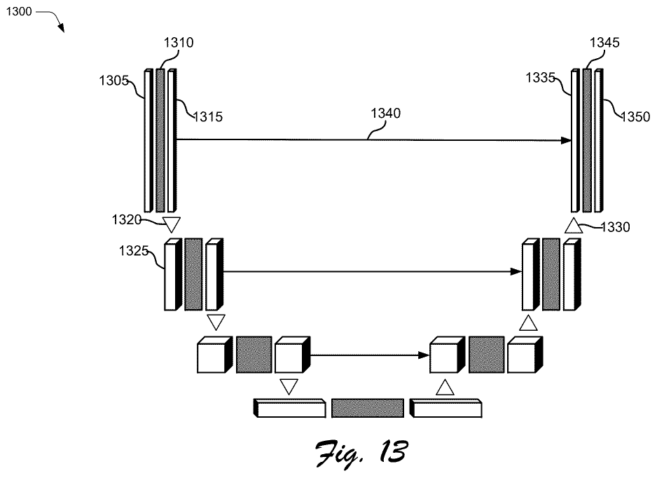

FIG. 13 shows an example 1300 of a U-Net 200 according to aspects of the present disclosure. In some examples, U-Net 200 is an example of the component that performs the reverse diffusion process 1225 of guided diffusion model 1200 described with reference to FIG. 12 and includes architectural elements of the generation model 1915 described with reference to FIG. 19. The U-Net 200 depicted in FIG. 13 is an example of, or includes aspects of, the architecture used within the reverse diffusion process described with reference to FIG. 12.

In some examples, diffusion models are based on a neural network architecture known as a U-Net. The U-Net 200 takes input features 1305 having an initial resolution and an initial number of channels and processes the input features 1305 using an initial neural network layer 1310 (e.g., a convolutional network layer) to produce intermediate features 1315. The intermediate features 1315 are then down-sampled using a down-sampling layer 1320 such that down-sampled features 1325 features have a resolution less than the initial resolution and a number of channels greater than the initial number of channels.

This process is repeated multiple times, and then the process is reversed. That is, the down-sampled features 1325 are up-sampled using up-sampling process 1330 to obtain up-sampled features 1335. The up-sampled features 1335 can be combined with intermediate features 1315 having the same resolution and number of channels via a skip connection 1340. These inputs are processed using a final neural network layer 1345 to produce output features 1350. In some cases, the output features 1350 have the same resolution as the initial resolution and the same number of channels as the initial number of channels.

In some cases, U-Net 200 takes additional input features to produce conditionally generated output. For example, the additional input features could include a vector representation of an input prompt. The additional input features can be combined with the intermediate features 1315 within the neural network at one or more layers. For example, a cross-attention module can be used to combine the additional input features and the intermediate features 1315.

### Inference: Conditional Generation

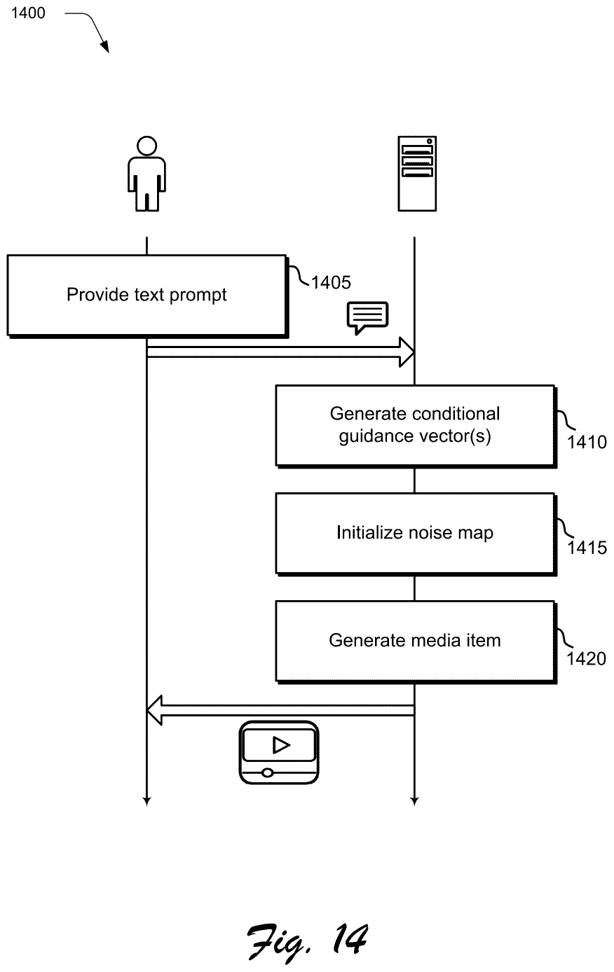

FIG. 14 shows an example of a method 1400 for conditional media generation according to aspects of the present disclosure. In some examples, method 1400 describes an operation of the generation model 1915 described with reference to FIG. 19 such as an application of the guided diffusion model 1200 described with reference to FIG. 12. In some examples, these operations are performed by a system including a processor executing a set of codes to control functional elements of an apparatus such as the media generation model described in FIG. 12.

Additionally or alternatively, steps of the method 1400 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1405, a user provides a text prompt describing content to be included in a generated media item. For example, a user may provide the prompt “a person playing with a cat.” In some examples, guidance can be provided in a form other than text, such as via an image, a sketch, or a layout.

At operation 1410, the system converts the text prompt (or other guidance) into a conditional guidance vector or other multi-dimensional representation. For example, text may be converted into a vector or a series of vectors using a transformer model, or a multimodal encoder. In some cases, the encoder for the conditional guidance is trained independently of the diffusion model.

At operation 1415, a noise map is initialized that includes random noise. The noise map may be in a pixel space or a latent space. By initializing a media item with random noise, different variations of a media item including the content described by the conditional guidance can be generated.

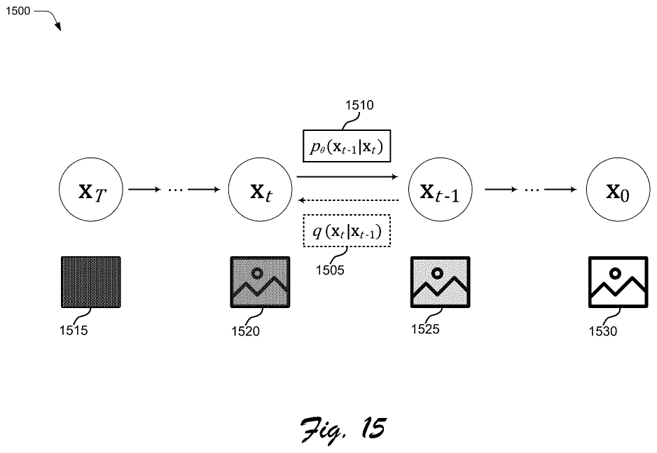

At operation 1420, the system generates a media item based on the noise map and the conditional guidance vector. For example, the media item may be generated using a reverse diffusion process as described with reference to FIG. 15.

### Inference: Reverse Diffusion

FIG. 15 shows a diffusion process 1500 according to aspects of the present disclosure. In some examples, diffusion process 1500 describes an operation of the generation model 1915 described with reference to FIG. 8, such as the reverse diffusion process 1225 of guided diffusion model 1200 described with reference to FIG. 12.

As described above with reference to FIG. 12, using a diffusion model can involve both a forward diffusion process 1505 for adding noise to a media item (or features in a latent space) and a reverse diffusion process 1510 for denoising the media item (or features) to obtain a denoised media item. The forward diffusion process 1505 can be represented as q(xₜ|xₜ₋₁), and the reverse diffusion process 1510 can be represented as p(xₜ₋₁|xₜ). In some cases, the forward diffusion process 1505 is used during training to generate media items with successively greater noise, and a neural network is trained to perform the reverse diffusion process 1510 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q (x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1510, the model begins with noisy data x_{T}, such as a noisy media item 1515 and denoises the data to obtain the p(xₜ₋₁|xₜ). At each step t−1, the reverse diffusion process 1510 takes xₜ, such as first intermediate media item 1520, and t as input. Here, t represents a step in the sequence of transitions associated with different noise levels, The reverse diffusion process 1510 outputs xₜ₋₁, such as second intermediate media item 1525 iteratively until x_{T} reverts back to x₀, the original media item 1530. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and % represents the generated item with high quality.

### Training: Machine Learning

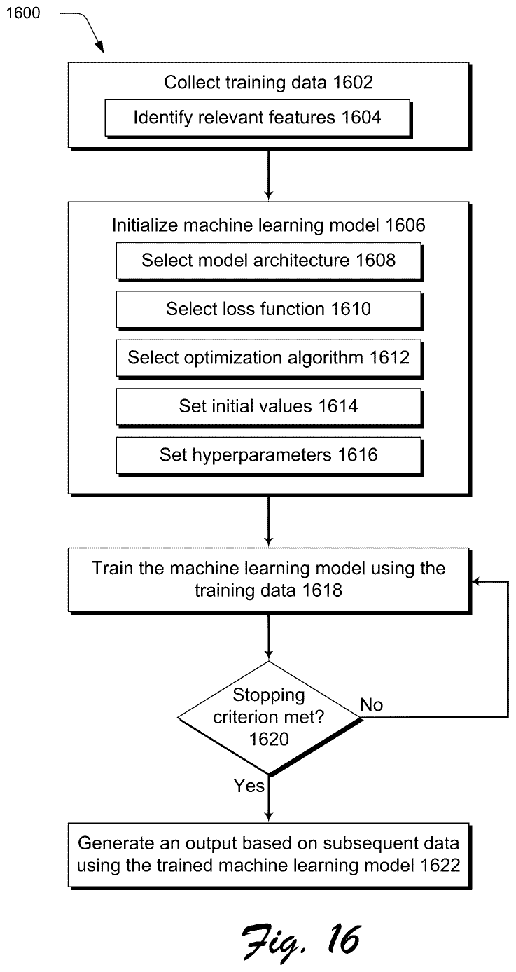

FIG. 16 is a flow diagram depicting an algorithm as a step-by-step procedure 1600 in an example implementation of operations performable for training a machine-learning model. In some embodiments, the procedure 1600 describes an operation of the training component 1925 described for configuring the generation model 1915 as described with reference to FIG. 19. The procedure 1600 provides one or more examples of generating training data, use of the training data to train a machine-learning model, and use of the trained machine-learning model to perform a task.

To begin in this example, a machine-learning system collects training data (block 1602) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1606). Initialization of the machine-learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1610). The loss function is utilized to measure a difference between an output of the machine-learning model (i.e., predictions) and target values (e.g., as expressed by the training data) to be used to train the machine-learning model. Additionally, an optimization algorithm is selected (block 1612) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1614) examples of which includes initializing weights and biases of nodes to improve efficiency in training and computational resources consumption as part of training. Hyperparameters are also set (block 1616) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1620), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), the procedure 1600 continues training of the machine-learning model using the training data (block 1618) in this example.

If the stopping criterion is met (“yes” from decision block 1620), the trained machine-learning model is then utilized to generate an output based on subsequent data (block 1622). The trained machine-learning model, for instance, is trained to perform a task as described above and therefore once trained is configured to perform that task based on subsequent data received as an input and processed by the machine-learning model.

### Training: Diffusion Training

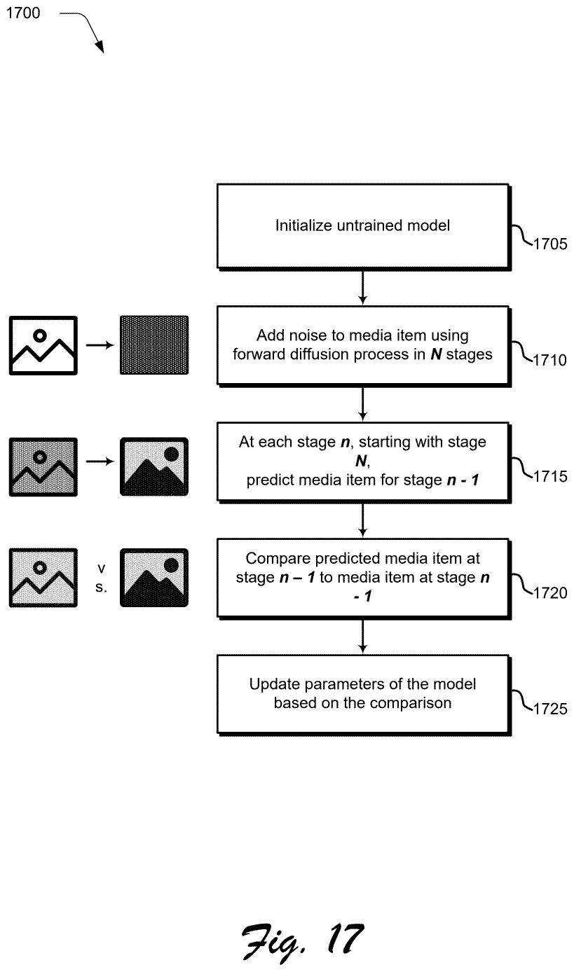

FIG. 17 shows an example of a method 1700 for training a diffusion model according to aspects of the present disclosure. In some embodiments, the method 1700 describes an operation of the training component 1925 described for configuring the generation model 1915 as described with reference to FIG. 19. The method 1700 represents an example for training a reverse diffusion process as described above with reference to FIG. 15. In some examples, these operations are performed by a system including a processor executing a set of codes to control functional elements of an apparatus, such as the guided diffusion model described in FIG. 12.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1715, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1720, the system compares predicted output (or features) at stage n−1 to an actual media item (or features), such as the output at stage n−1 or the original input. For example, given observed data x, the diffusion model may be trained to minimize the variational upper bound of the negative log-likelihood −log p₀(x) of the training data.

At operation 1725, the system updates parameters of the model based on the comparison. For example, parameters of a U-Net may be updated using gradient descent. Time-dependent parameters of the Gaussian transitions can also be learned.

### System: Computing Device

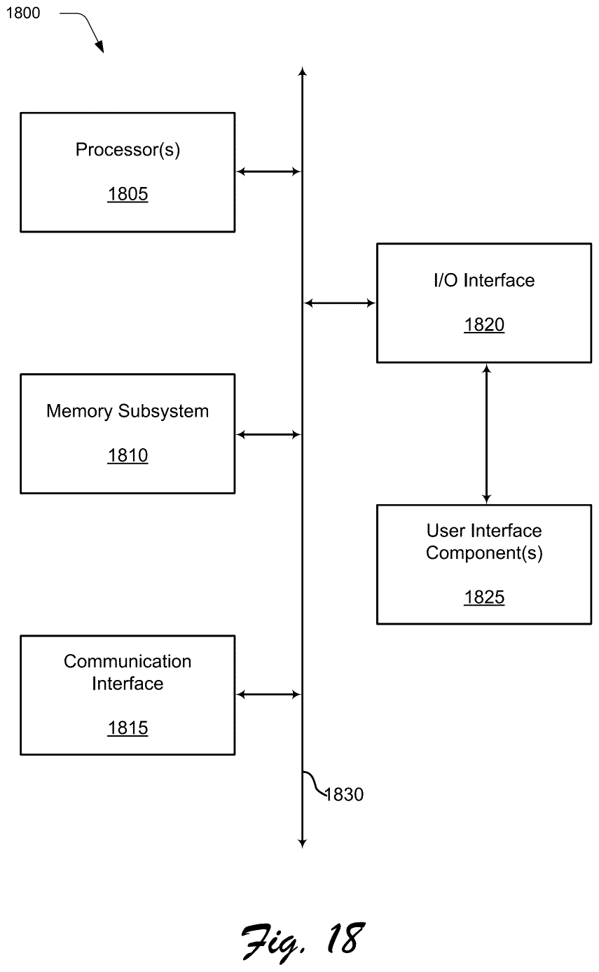

FIG. 18 shows an example of a computing device 1800 according to aspects of the present disclosure. The computing device 1800 may be an example of the generation apparatus 1900 described with reference to FIG. 19. In one aspect, computing device 1800 includes processor(s) 1805, memory subsystem 1810, communication interface 1815, I/O interface 1820, user interface component(s) 1825, and channel 1830.

In some embodiments, computing device 1800 is an example of, or includes aspects of, the media generation model of FIG. 12. In some embodiments, computing device 1800 includes one or more processors 1805 that can execute instructions stored in memory subsystem 1810 to perform media generation.

According to some aspects, computing device 1800 includes one or more processors 1805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1815 operates at a boundary between communicating entities (such as computing device 1800, one or more user devices, a cloud, and one or more databases) and channel 1830 and can record and process communications. In some cases, communication interface 1815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1820 is controlled by an I/O controller to manage input and output signals for computing device 1800. In some cases, I/O interface 1820 manages peripherals not integrated into computing device 1800. In some cases, I/O interface 1820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1820 or via hardware components controlled by the I/O controller.

According to some aspects, user interface component(s) 1825 enable a user to interact with computing device 1800. In some cases, user interface component(s) 1825 include an audio device, such as an external speaker system, an external display device such as a display screen, an input device (e.g., a remote-control device interfaced with a user interface directly or through the I/O controller), or a combination thereof. In some cases, user interface component(s) 1825 include a GUI.

### System: Generation Apparatus

FIG. 19 shows an example of a generation apparatus 1900 according to aspects of the present disclosure. Generation apparatus 1900 may include an example of, or aspects of, the guided diffusion model described with reference to FIG. 12 and the U-Net described with reference to FIG. 13. In some embodiments, generation apparatus 1900 includes processor unit 1905, memory unit 1910, generation model 1915, I/O module 1920, and training component 1925. Training component 1925 updates parameters of the generation model 1915 stored in memory unit 1910. In some examples, the training component 1925 is located outside the generation apparatus 1900.

Processor unit 1905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1905 is configured to operate a memory array using a memory controller. In other cases, a memory controller is integrated into processor unit 1905. In some cases, processor unit 1905 is configured to execute computer-readable instructions stored in memory unit 1910 to perform various functions. In some aspects, processor unit 1905 includes special purpose components for modem processing, baseband processing, digital signal processing, or transmission processing. According to some aspects, processor unit 1905 comprises one or more processors described with reference to FIG. 18.

Memory unit 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1905 to perform various functions described herein.

In some cases, memory unit 1910 includes a basic input/output system (BIOS) that controls basic hardware or software operations, such as an interaction with peripheral components or devices. In some cases, memory unit 1910 includes a memory controller that operates memory cells of memory unit 1910. For example, the memory controller may include a row decoder, column decoder, or both. In some cases, memory cells within memory unit 1910 store information in the form of a logical state. According to some aspects, memory unit 1910 is an example of the memory subsystem 1810 described with reference to FIG. 18.

According to some aspects, generation apparatus 1900 uses one or more processors of processor unit 1905 to execute instructions stored in memory unit 1910 to perform functions described herein. For example, the generation apparatus 1900 may train a machine learning model, receive a query for processing by the machine learning model that specifies visual aspects to be included in a generated image, sequentially generate image components that represent the visual aspects, integrate the image components to generate a digital image for output that includes the visual aspects, receive a request to apply an edit to a particular image component, and leverage the machine learning model to generate an edited digital image that depicts the particular image component with the edit applied.

The memory unit 1910 may include a generation model 1915 trained to receive a query for processing that specifies visual aspects to be included in a generated image, sequentially generate image components that represent the visual aspects, integrate the image components to generate a digital image for output that includes the visual aspects, receive a request to apply an edit to a particular image component and generate an edited digital image that depicts the particular image component with the edit applied. For example, after training, the generation model 1915 may perform inferencing operations as described with reference to FIGS. 14 and 15 to perform various aspects of sequential image generation and editing.

In some embodiments, the generation model 1915 is an Artificial neural network (ANN) such as the guided diffusion model described with reference to FIG. 12 and the U-Net described with reference to FIG. 2. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of generation model 1915 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1925 may train the generation model 1915. For example, parameters of the generation model 1915 can be learned or estimated from training data and then used to make predictions or perform tasks based on learned patterns and relationships in the data. In some examples, the parameters are adjusted during the training process to minimize a loss function or maximize a performance metric, e.g., as described with reference to FIGS. 16 and 17. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the generation model 1915 can be used to make predictions on new, unseen data (i.e., during inference).

I/O module 1920 receives inputs from and transmits outputs of the generation apparatus 1900 to other devices or users. For example, I/O module 1920 receives inputs for the generation model 1915 and transmits outputs of the generation model 1915. According to some aspects, I/O module 1920 is an example of the I/O interface 1820 described with reference to FIG. 18.

### Example System and Device

FIG. 20 illustrates an example system generally at 2000 that includes an example computing device 2002 that is representative of one or more computing systems and/or devices that implement the various techniques described herein. This is illustrated through inclusion of the generation module 116. The computing device 2002 is configurable, for example, as a server of a service provider, a device associated with a client (e.g., a client device), an on-chip system, and/or any other suitable computing device or computing system.

The example computing device 2002 as illustrated includes a processing system 2004, one or more computer-readable media 2006, and one or more I/O interface 2008 that are communicatively coupled, one to another. Although not shown, the computing device 2002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2004 is representative of functionality to perform one or more operations using hardware. Accordingly, the processing system 2004 is illustrated as including hardware element 2010 that is configurable as processors, functional blocks, and so forth. This includes implementation in hardware as an application specific integrated circuit or other logic device formed using one or more semiconductors. The hardware elements 2010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 2006 is illustrated as including memory/storage 2012. The memory/storage 2012 represents memory/storage capacity associated with one or more computer-readable media. The memory/storage 2012 includes volatile media (such as random access memory (RAM)) and/or nonvolatile media (such as read only memory (ROM), Flash memory, optical disks, magnetic disks, and so forth). The memory/storage 2012 includes fixed media (e.g., RAM, ROM, a fixed hard drive, and so on) as well as removable media (e.g., Flash memory, a removable hard drive, an optical disc, and so forth). The computer-readable media 2006 is configurable in a variety of other ways as further described below.

Input/output interface(s) 2008 are representative of functionality to allow a user to enter commands and information to computing device 2002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 2002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 2002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2010 and computer-readable media 2006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 2010. The computing device 2002 is configured to implement particular instructions and/or functions corresponding to the software and/or hardware modules. Accordingly, implementation of a module that is executable by the computing device 2002 as software is achieved at least partially in hardware, e.g., through use of computer-readable storage media and/or hardware elements 2010 of the processing system 2004. The instructions and/or functions are executable/operable by one or more articles of manufacture (for example, one or more computing devices 2002 and/or processing systems 2004) to implement techniques, modules, and examples described herein.

The techniques described herein are supported by various configurations of the computing device 2002 and are not limited to the specific examples of the techniques described herein. This functionality is also implementable all or in part through use of a distributed system, such as over a “cloud” 2014 via a platform 2016 as described below.

The cloud 2014 includes and/or is representative of a platform 2016 for resources 2018. The platform 2016 abstracts underlying functionality of hardware (e.g., servers) and software resources of the cloud 2014. The resources 2018 include applications and/or data that can be utilized while computer processing is executed on servers that are remote from the computing device 2002. Resources 2018 can also include services provided over the Internet and/or through a subscriber network, such as a cellular or Wi-Fi network.

The platform 2016 abstracts resources and functions to connect the computing device 2002 with other computing devices. The platform 2016 also serves to abstract scaling of resources to provide a corresponding level of scale to encountered demand for the resources 2018 that are implemented via the platform 2016. Accordingly, in an interconnected device embodiment, implementation of functionality described herein is distributable throughout the system 2000. For example, the functionality is implementable in part on the computing device 2002 as well as via the platform 2016 that abstracts the functionality of the cloud 2014.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a query for processing by a machine learning model that specifies visual aspects to be included in a generated image;
sequentially generating, by the machine learning model, image components that represent the visual aspects, each image component conditioned on previously generated image components; and
presenting, by the processing device, a digital image that includes the visual aspects by integrating the image components using the machine learning model.

2. The method as described in claim 1, wherein the machine learning model is a multimodal large language model configured to include an autoregressive diffusion transformer architecture.

3. The method as described in claim 1, wherein the image components are generated based on semantic properties of the query.

4. The method as described in claim 1, wherein the image components include a layout representation that denotes a spatial arrangement of an object within a scene and the digital image depicts the object within the scene in accordance with the layout representation.

5. The method as described in claim 4, wherein the image components include a background representation that depicts the scene independent of the object, generation of the background representation conditioned on the layout representation.

6. The method as described in claim 5, wherein the image components include an object representation that depicts the object independent of the scene, generation of the object representation conditioned on the background representation and the layout representation.

7. The method as described in claim 1, further comprising training the machine learning model in a first mode to generate layout representations and image captions based on text-based queries, and training the machine learning model in a second mode to generate digital images based on text-based queries using an iterative denoising process.

8. The method as described in claim 1, further comprising generating a processing plan based on semantic properties of the query that specifies a sequence for the machine learning model to generate the image components.

9. The method as described in claim 1, further comprising receiving a request to apply an edit to a particular image component; and generating an edited digital image that depicts the particular image component with the edit applied and preserves a visual appearance of unedited image components.

10. A system comprising:
a memory component; and
a processing device coupled to the memory component, the processing device to perform operations including:
receiving a query for processing by a machine learning model that includes visual aspects to be included in a generated image;
generating, by the machine learning model, a digital image based on the query that includes the visual aspects by sequentially generating and integrating image components that represent the visual aspects;
receiving a request to apply an edit to a particular image component; and
generating, by the machine learning model, an edited digital image that depicts the particular image component with the edit applied and preserves a visual appearance of unedited image components.

11. The system as described in claim 10, wherein the machine learning model generates one or more of the image components using an iterative denoising process.

12. The system as described in claim 10, wherein generation of a particular image component includes generating a contextual embedding that represents previously generated image components and conditioning the machine learning model on the contextual embedding to generate the particular image component.

13. The system as described in claim 10, wherein the edit includes an input to modify a visual attribute of the particular image component while maintaining a spatial position of the particular image component within the digital image.

14. The system as described in claim 10, wherein the image components include a layout representation that denotes a spatial arrangement of one or more objects to be included in a scene, a background representation that depicts the scene independent of the one or more objects, and an object representation for each of the one or more objects.

15. The system as described in claim 14, wherein the edit includes an input to replace the particular image component with a different object of a same category while preserving the layout representation.

16. The system as described in claim 14, wherein the edit includes an input to adjust the spatial arrangement of the particular image component within the scene by modifying the layout representation, and the edited digital image depicts the background representation and the object representations positioned in accordance with the modified layout representation.

17. A non-transitory computer-readable storage medium storing executable instructions, which when executed by a processing device, cause the processing device to perform operations comprising:
receiving a query for processing by a machine learning model that specifies visual aspects to be included in a generated image;
generating, sequentially by the machine learning model, image components that represent the visual aspects, each image component conditioned on previously generated image components; and
outputting a digital image that includes the visual aspects by integrating the image components using the machine learning model.

18. The non-transitory computer-readable storage medium as described in claim 17, wherein generating the image components includes generating a processing plan based on semantic properties of the query that specifies a sequence for the machine learning model to generate the image components.

19. The non-transitory computer-readable storage medium as described in claim 17, wherein the machine learning model is a multimodal large language model configured to include an autoregressive diffusion transformer architecture.

20. The non-transitory computer-readable storage medium as described in claim 17, the operations further comprising receiving a request to apply an edit to a particular image component; and generating an edited digital image that depicts the particular image component with the edit applied and preserves a visual appearance of unedited image components.
